(19) United States
(12) Patent Application Publication
(10) Pub. No.: US 2021/0009897 A1
(43) Pub. Date: Jan. 14, 2021

(54) METHOD OF PREPARING MECHANOLUMINESCENT MATERIAL AND COMPOSITE MATERIAL CONTAINING IT

(71) Applicant: City University of Hong Kong, Kowloon (HK)

(72) Inventors: Feng Wang, New Territories (HK); Yangyang Du, Sham Shui Po (HK); Tianying Sun, Kowloon (HK); Jianxiong Zhao, Kowloon (HK)

(21) Appl. No.: 16/504,576

(22) Filed: Jul. 8, 2019

(51) Int. Cl. C09K 11/77; C09K 11/57; C09K 11/02

(52) U.S. Cl. CPC C09K 11/7746; G01L 1/24; C09K 11/02; C09K 11/576

(57) ABSTRACT

A method of preparing a mechanoluminescent material includes the steps of: a) providing a mixture including precursors of a base material, a fluxing agent, and at least one lanthanide ion; b) heat-treating the mixture to obtain the mechanoluminescent material; and c) optionally grinding the mechanoluminescent material into powder form; wherein the fluxing agent facilitates incorporation of the at least one lanthanide ion into the base material. A composite material includes a first mechanoluminescent material, wherein the first mechanoluminescent material includes at least 2-3 mol % of a lanthanide ion.

### TECHNICAL FIELD

The present invention relates to a method of preparing a mechanoluminescent material. The present invention also pertains to a composite material containing the mechanoluminescent material.

### BACKGROUND OF THE INVENTION

Mechanoluminescent materials which emit visible light under mechanical stimuli are important for the technological application. These materials are composed of organic complexes or inorganic crystals and they are potentially useful for constructing optoelectrical devices without requiring optical or electrical sources of energy for their operation. For example, mechanoluminescent materials may be used in modern technology such as wind-driven display, optical sensor, and artificial skin. However, it has been challenging to develop a mechanoluminescence (ML) system with multi ML emission colors which is vital for practical application of these systems, particularly in the development of mechanoluminescent materials displaying high and equal brightness across the whole spectral range.

Thus far, materials that are capable of producing sufficiently bright and self-recoverable ML for the aforementioned applications are rarely reported. In general, efficient mechanoluminescent materials may be composed of piezoelectric materials such as ZnS, CaZnOS, and LiNbO₃, which promote the formation of lattice-defect complexes by strain-induced piezoelectric potential due to strong electron-lattice coupling. Dopant ions such as Mn²⁺ are often introduced in substitution for Zn²⁺ to provide additional energy levels to tune the emission profiles. Due to the close chemical properties between Mn²⁺ and Zn²⁺, high concentration of Mn²⁺ ions can be conveniently incorporated into the host lattice without deleterious effects.

Nonetheless, in view of the development of multi ML emission colors, lanthanide ions may be used as the dopant ions as lanthanide ions are capable of giving highly designable emission profiles spanning almost the whole visible spectral range. However, owing to the low compatibility between lanthanide dopants and semiconducting ML host materials, attempts that made to obtain active ML materials with lanthanide dopants have been resulting in very low doping possibility of lanthanide activator, such as Sm³⁺ (1 mol %), Er³⁺ (0.5 mol %), and Nd³⁺ (2 mol %) activators, rendering very limited emission colors and weak ML emission intensities.

Accordingly, there is a strong need for developing an improved method for preparing ML materials with effective lanthanide doping for bright multicolor ML emission.

### SUMMARY OF THE INVENTION

The inventors unexpectedly found that during the preparation of a mechanoluminescent material, the presence of a fluxing agent is particularly advantageous in increasing the effective doping concentration of lanthanide ion into the host lattice. In particular, with presence of the fluxing agent, the method of the present invention allows for more than 2% lanthanide ions to be effectively doped into the ML host materials. The availability of more activator ions (i.e. lanthanide ions) in the host lattice renders brighter ML emission.

In a first aspect, the present invention relates to a method of preparing a mechanoluminescent material comprising the steps of:
a) providing a mixture including precursors of a base material, a fluxing agent, and at least one lanthanide ion;
b) heat-treating the mixture to obtain the mechanoluminescent material; and
c) optionally grinding the mechanoluminescent material into powder form;

wherein the fluxing agent facilitates incorporation of the at least one lanthanide ion into the base material.

In particular, the mechanoluminescent material includes lanthanide-doped CaZnOS crystals having a general formula of CaZnOS:Ln³⁺.

Preferably, the mechanoluminescent material includes at least 2-3 mol % of doped lanthanide.

In an embodiment, the precursors of the base material includes calcium carbonate and zinc sulfide. In particular, the calcium carbonate is provided at a predetermined atomic ratio with respect to the at least one lanthanide ion. The fluxing agent includes a lithium compound, preferably being provided in a molar percentage of 6% in the mixture. The lanthanide ion includes at least one of Tb³⁺, Pr³⁺, Nd³⁺, Sm³⁺, Eu³⁺, Dy³⁺, Ho³⁺, Er³⁺, Tm³⁺ or Yb³⁺. In particular, the lanthanide ion may be provided by lanthanide fluoride.

In a second aspect, there is provided a composite material comprising a first mechanoluminescent material, wherein the first mechanoluminescent material includes at least 2-3 mol % of a lanthanide ion.

Preferably, the first mechanoluminescent material has a general formula of CaZnOS:Ln³⁺, wherein Ln³⁺ is a lanthanide ion selected from the group consisting of Tb³⁺, Pr³⁺, Nd³⁺, Sm³⁺, Eu³⁺, Dy³⁺, Ho³⁺, Er³⁺, Tm³⁺ and Yb³⁺.

In an embodiment, the composite material further includes a second mechanoluminescent material having an emission wavelength different from the first mechanoluminescent material. In particular, the first mechanoluminescent material and the second mechanoluminescent material are provided in a mixture at a predetermined weight ratio thereby tuning the emission wavelength of the composite material.

Preferably, the first mechanoluminescent material includes CaZnOS:Tb³⁺; and the second mechanoluminescent material includes CaZnOS:Mn²⁺.

Those skilled in the art will appreciate that the invention described herein is susceptible to variations and modifications other than those specifically described. The invention includes all such variations and modifications. The invention also includes all steps and features referred to or indicated in the specification, individually or collectively, and any and all combinations of the steps or features.

Other features and aspects of the invention will become apparent by consideration of the following detailed description and accompanying drawings.

### BRIEF DESCRIPTION OF THE DRAWINGS

FIGS. 1a-e provide graphs characterizing CaZnOS, wherein: FIG. 1a shows the schematic representation of CaZnOS crystal structure; FIG. 1b shows the XRD patterns of Tb³⁺-doped CaZnOS synthesized in the absence of LiNO₃; FIG. 1c shows the XRD patterns of Tb³⁺-doped CaZnOS prepared in the presence of LiNO₃; FIG. 1d shows a plot of cell volume of CaZnOS:Tb³⁺ against Tb³⁺ precursor concentration derived from the XRD patterns of FIG. 1c; and FIG. 1e shows an XPS spectrum of CaZnOS:Tb³⁺ (3% Tb³⁺) after purification with water for three times.

FIGS. 2a-d provide emission characterizations of CaZnOS:Tb³⁺ under an excitation of 285 nm, wherein: FIG. 2a shows the simplified energy-level diagram of CaZnOS:Tb³⁺, and shows the cross-relaxation between Tb³⁺ ions; FIG. 2b shows the photoluminescence (PL) spectra of CaZnOS:Tb³⁺ under an excitation of 285 nm; FIG. 2c shows a plot of I₄₁₈ (⁵D₃→⁷F₈) to I₅₄₅ (⁵D₄→⁷F₅) against Tb³⁺ precursor concentration, with the plot showing I₄₁₈ (⁵D₃→⁷F₅) to I₅₄₅ (⁵D₄→⁷F₅) emission intensity ratio of CaZnOS:Tb³⁺ prepared without or with LiNO₃; and FIG. 2d shows a plot of PL intensity against Tb³⁺ precursor concentration, the plot showing PL intensity of CaZnOS:Tb³⁺ prepared without or with LiNO₃.

FIGS. 3a-d provide graphs showing the photoluminescence properties of CaZnOS:Tb³⁺ prepared in the absence of LiNO₃, wherein: FIG. 3a shows the PL spectra of CaZnOS:Tb³⁺ prepared in the absence of LiNO₃ by using TbF₃; FIG. 3b shows the PL spectra of CaZnOS:Tb³⁺ prepared in the absence of LiNO₃ by using Tb₄O₇, with the samples excited at 285 nm and the spectra normalized at 545 nm; FIG. 3c shows a plot of I₄₁₈ (⁵D₃→⁷F₈) to I₅₄₅ (⁵D₄→⁷F₅) against Tb³⁺ precursor concentration, the plot showing I₄₁₈ (⁵D₃→⁷F₈) to I₅₄₅ (⁵D₄→⁷F₅) emission intensity ratio of CaZnOS:Tb³⁺ prepared using TbF₃; and FIG. 3d shows a plot of PL intensity against Tb³⁺ precursor concentration under an excitation of 486 nm, the plot showing the PL intensity of CaZnOS:Tb³⁺ prepared with Tb₄O₇.

FIG. 4 refers to a plot of intensity against wavelength showing the intrinsic defect emission by undoped CaZnOS and ML emission from 1% Tb³⁺-doped CaZnOS.

FIGS. 5a-c provide graphs showing the ML properties of CaZnOS:Tb³⁺ crystals, wherein: FIG. 5a shows the ML spectra of the CaZnOS:Tb³⁺ crystals as a function of Tb³⁺ precursor concentration under constant sliding force of 40N; FIG. 5b shows the ML spectra of the CaZnOS:Tb³⁺ (3% Tb³⁺) crystals under various applied forces; and FIG. 5c shows a plot of integral ML intensity against applied force of the CaZnOS:Tb³⁺ (3% Tb³⁺) crystals, with the insert showing the images of the sample under forces of 10N, 30N, and 50N.

FIGS. 6a-g refers to plots of characterization of Mn-doped CaZnOS, wherein: FIG. 6a shows the XRD patterns of CaZnOS doped with different concentrations of Mn²⁺ ions; FIG. 6b shows the ML intensity for CaZnOS:Mn²⁺ as a function of Mn²⁺ concentration, and the sample doped with 4% of Mn²⁺ displayed the most intense ML and was used as a benchmark for CaZnOS:Tb (3% Tb³⁺); FIG. 6c shows the ML spectrum of CaZnOS:Mn/CaZnOS:Tb mixture (1:1 weight ratio), with the inset showing the corresponding ML photograph, and the observation of emission peaks from both components with similar intensity suggests comparative ML performance of the CaZnOS:Mn and CaZnOS:Tb; FIG. 6d shows the particle size distribution of the CaZnOS:Tb (3% Tb³⁺) crystals; FIG. 6e shows the EDX element maps of a typical CaZnOS:Tb (3% Tb³⁺) particle; FIG. 6f shows the particle size distribution of the CaZnOS:Mn (4% Mn²⁺) crystals; and FIG. 6g shows the EDX element maps of a typical CaZnOS:Mn (4% Mn²⁺) particle, wherein the similar crystalline size of CaZnOS:Mn and CaZnOS:Tb phosphors justifies the similarity in ML intensity.

FIGS. 7a and 7b provide graphs showing ML properties of CaZnOS:Mn (4% Mn²⁺) under forces, wherein FIG. 7a shows the ML spectrum of the CaZnOS:Mn (4% Mn²⁺) under various amount of applied forces, and FIG. 7b shows the plot of integral ML intensity of the CaZnOS:Mn (4% Mn²⁺) against applied force, the insert showing the ML images of the CaZnOS:Mn (4% Mn²⁺) under a force of 10N, 30N, or 50N, respectively.

FIGS. 8a-i provide plots showing XRD patterns of different lanthanide-doped CaZnOS, wherein: FIG. 8a shows the XRD patterns of Pr³⁺-doped CaZnOS; FIG. 8b shows the XRD patterns of Nd³⁺-doped CaZnOS; FIG. 8c shows the XRD patterns of Sm³⁺-doped CaZnOS; FIG. 8d shows the XRD patterns of Eu³⁺-doped CaZnOS; FIG. 8e shows the XRD patterns of Dy³⁺-doped CaZnOS; FIG. 8f shows the XRD patterns of Ho³⁺-doped CaZnOS; FIG. 8g shows the XRD patterns of Er³⁺-doped CaZnOS; FIG. 8h shows the XRD patterns of Tm³⁺-doped CaZnOS; and FIG. 8i shows the XRD patterns of Yb³⁺-doped CaZnOS.

FIGS. 9a-h provides graphs of ML intensities as a function of precursor concentration for different lanthanide-doped CaZnOS crystals, wherein; FIG. 9a shows the ML intensities as a function of precursor concentration for CaZnOS:Pr³⁺ crystals; FIG. 9b shows the ML intensities as a function of precursor concentration for CaZnOS:Nd³⁺ crystals; FIG. 9c shows the ML intensities as a function of precursor concentration for CaZnOS:Sm³⁺ crystals; FIG. 9d shows the ML intensities as a function of precursor concentration for CaZnOS:Eu³⁺ crystals; FIG. 9e shows the ML intensities as a function of precursor concentration for CaZnOS:Dy³⁺ crystals; FIG. 9f shows the ML intensities as a function of precursor concentration for CaZnOS:Ho³⁺ crystals; FIG. 9g shows the ML intensities as a function of precursor concentration for CaZnOS:Er³⁺ crystals; and FIG. 9h shows the ML intensities as a function of precursor concentration for CaZnOS:Yb³⁺ crystals.

FIGS. 10a-j refers to plots of ML spectra and Commission International de l'Eclairage (CIE) chromaticity coordinates of different lanthanide-doped CaZnOS crystals, wherein FIG. 10a is a ML spectrum of CaZnOS:Pr³⁺ crystals; FIG. 10b is a ML spectrum of CaZnOS:Ho³⁺ crystals; FIG. 10c is a ML spectrum of CaZnOS:Er³⁺ crystals; FIG. 10d is a ML spectrum of CaZnOS:Dy³⁺ crystals; FIG. 10e is a ML spectrum of CaZnOS:Sm³⁺ crystals; FIG. 10f is a ML spectrum of CaZnOS:Eu³⁺ crystals; FIG. 10g is a ML spectrum of CaZnOS:Tm³⁺ crystals; FIG. 10h is a ML spectrum of CaZnOS:Nd³⁺ crystals; FIG. 10i is a ML spectrum of CaZnOS:Yb³⁺ crystals; and FIG. 10j shows a plot of CIE chromaticity coordinates of the multicolor emissions from the lanthanide-doped CaZnOS.

FIGS. 11a and 11b provide graphs demonstrating the ML multicolor tuning effect of the doped CaZnOS materials, wherein FIG. 11a shows the ML multicolor tuning by mixing CaZnOS:Tb (denoted as ‘G’) and CaZnOS:Mn (denoted as ‘R’) at different ratios, and FIG. 11b shows a plot of CIE chromaticity coordinates of the multicolor emissions from the samples in FIG. 11a.

FIGS. 12a and 12b provide graphs of peak intensity of CaZnOS:Tb and CaZnOS:Mn against different sliding cycles, wherein FIG. 12a shows the ML intensities of CaZnOS:Tb at 545 nm under repeated sliding force of 25 N at the same position; and FIG. 12b shows the ML intensities of CaZnOS:Mn at 611 nm under repeated sliding force of 25 N at the same position, the decrease of ML intensity in the first 10 cycles was attributed to the deformation of the composite film that resulted in depletion of CaZnOS powders.

FIG. 13a-c provides graphs of upconversion luminescence properties of the mechanoluminescent materials under laser excitation, wherein FIG. 13a shows the upconversion luminescence spectrum of CaZnOS:Er (1%) and CaZnOS:Yb/Er (1%/1%) under 980 nm laser excitation; FIG. 13b shows the upconversion luminescence spectrum of CaZnOS:Pr (1%) under 980 nm laser excitation; and FIG. 13c shows the upconversion luminescence spectra of CaZnOS:Er (1%) and CaZnOS:Yb/Er (1%/1%) under 1532 nm laser excitation, with the emission spectra readily tuned by controlling the composition of the materials and/or excitation wavelength.

FIGS. 14a-d demonstrate the stress sensing application of Tb- and Mn-doped CaZnOS ML device, wherein FIG. 14a shows the visualization of handwriting trajectory through long time exposure Tb-doped CaZnOS ML imaging; FIG. 14b shows the distribution of relative ML intensity extracted from ML image in FIG. 14a according to the gray scale value; FIG. 14c shows the visualization of handwriting trajectory through long time exposure Mn-doped CaZnOS ML imaging; and FIG. 14d shows the distribution of relative ML intensity extracted from ML image in FIG. 14c according to the gray scale value.

FIGS. 15a and 15b provide photographs of anti-counterfeiting patterns encoded with ML strips, wherein FIG. 15a shows the photographs of anti-counterfeiting patterns encoded with ML strips of varying colors sequence, and FIG. 15b shows the photographs of anti-counterfeiting patterns encoded with ML strips of varying strip width.

### DETAILED DESCRIPTION OF THE INVENTION

Unless otherwise defined, all technical terms used herein have the same meaning as commonly understood by one skilled in the art to which the invention belongs.

As used herein, “comprising” means including the following elements but not excluding others. “Essentially consisting of” means that the material consists of the respective element along with usually and unavoidable impurities such as side products and components usually resulting from the respective preparation or method for obtaining the material such as traces of further components or solvents. The expression that a material is certain element is to be understood for meaning “essentially consists of” said element. As used herein, the forms “a,” “an,” and “the,” are intended to include the singular and plural forms unless the context clearly indicates otherwise.

In the first aspect of the present invention, there is provided a method of preparing a luminescent material particularly a mechanoluminescent material. The term “mechanoluminescent material” refers to any materials that are capable of emitting light under mechanical stimuli. In particular, the mechanoluminescent material may emit visible light, near infrared (NIR) light, and/or UV light under the mechanical stimuli. In one embodiment, the mechanoluminescent material may comprise a base material doped with a dopant ion.

The term “base material” refers to a piezoelectric material which promotes the formation of lattice-defect complexes by strain-induced piezoelectric potential due to strong electron-lattice coupling. These lattice-defect complexes function as active energy carriers and migration centers in mechanoluminescence (ML) processes. In particular, the piezoelectric material may be ZnS, CaZnOS or LiNbO₃. In an embodiment, the base material is a piezoelectric material having or essentially consisting of CaZnOS.

The term “dopant ion” refers to an ion that is able to capture strain-induced energies associated with lattice defects, and subsequently produces photon emission at high efficiency. The dopant ions can also introduce additional energy levels to tune the emission profiles of the mechanoluminescent materials. These ions are usually incorporated into the base material (i.e. the host) by substituting the ions in the base material. In a preferred embodiment, the dopant ions are lanthanide ions.

Turning to the method of the present invention, the method may commence at step a) providing a mixture including precursors of a base material, a fluxing agent, and at least one lanthanide ion. The precursors, fluxing agent, and at least one lanthanide ion may be provided in solid form particularly as powder and mixed thoroughly for subsequent processing. In an embodiment, the precursors powder, fluxing agent powder and a lanthanide compound are placed in a container such as an agate mortar and mixed thoroughly and may be further ground into finer powders.

The precursors include suitable compounds for preparing the base material of interest. In an embodiment, the base material is CaZnOS. The precursors of CaZnOS may include one or more of calcium carbonate, zinc sulfide, calcium oxide, calcium chloride, calcium hydroxide, calcium nitrate, calcium sulfide, zinc carbonate, zinc hydroxide, zinc nitrate, zinc oxide, and zinc chloride. Each of the precursors may be provided at a particular ratio. In an embodiment where the precursors include calcium carbonate and zinc sulfide, the atomic ratio of calcium carbonate to the lanthanide ion present in the mixture is 1-x:x. The value x may be any number between 0.001 to 0.1, particularly may be 0.002, 0.005, 0.01, 0.02, 0.03, 0.04 or 0.08.

The lanthanide ion may include at least one of Tb³⁺, Pr³⁺, Nd³⁺, Sm³⁺, Eu³⁺, Dy³⁺, Ho³⁺, Er³⁺, Tm³⁺ or Yb³⁺. These ions may be provided by lanthanide compounds of any suitable forms such as oxide, fluoride, chloride, nitrate, and the like. Preferably, the lanthanide ion is provided in the form of lanthanide fluoride. The lanthanide fluoride may be commercially available or prepared by any suitable methods. In an embodiment, the lanthanide fluoride may be prepared from a corresponding lanthanide oxide. In particular, the preparation includes the steps of: dissolving a lanthanide oxide with nitric acid; subjecting the dissolved lanthanide oxide with excessive amount of NH₄F to precipitate the lanthanide fluoride; and drying the lanthanide fluoride precipitate under an elevated temperature.

Preferably, the lanthanide oxide may be selected from the group consisting of Pr₂O₃, Nd₂O₃, Sm₂O₃, Eu₂O₃, Dy₂O₃, Ho₂O₃, Er₂O₃, Tm₂O₃ and Yb₂O₃ and can be dissolved in nitric acid. The acidic solution is then added with excessive amount of NH₄F so as to precipitate the corresponding lanthanide fluoride out. The lanthanide fluoride precipitate may be collected by method such as simple filtration or suction filtration. The collected lanthanide fluoride may then be dried in an oven at 100° C. for at least 8 hours for subsequent use.

In an embodiment of the step a), the mixture includes a lanthanide fluoride to provide the lanthanide ion, and the lanthanide fluoride is optionally prepared from a lanthanide oxide as described above. The inventors through their own research, trials, and experiments, have devised that the use of lanthanide fluoride as the source of lanthanide ion is of particularly advantageous. For example, the fluoride feature may significantly reduce the melting point of the lanthanide compound such that the doping reaction may be carried out at a lower temperature. The fluoride may also prevent the formation of lanthanide ions with higher valence state such as an oxidation state of +4. In addition, the fluoride feature may promote the chemical reaction between the precursors of the base material, reducing the reaction temperature thereof and therefore preventing formation of undesired components during the reaction.

The term “fluxing agent” used herein refers to an agent that can facilitate incorporation of the at least one lanthanide ion, i.e. the dopant ions, into the base material. In particular, the fluxing agent is an agent that is capable of promoting interdiffusion of ions into the lattice of the base material while itself is not doped into the lattice of the base material. In the present invention, the dopant ions are incorporated into the base material in the presence of the fluxing agent, under optimum conditions, to produce a mechanoluminescent material having at least 2-3 mol % of the dopant ion. In an embodiment herein, the resultant mechanoluminescent material contains about 2 mol % to about 3 mol %, or about 3 mol % of doped lanthanide.

In an embodiment, the fluxing agent includes a lithium compound. The lithium compound may be selected from the group consisting of lithium nitrate, lithium fluoride, lithium carbonate, lithium chloride, lithium oxide, lithium hydroxide, lithium sulfide, lithium hydrogen carbonate, lithium nitrite, lithium nitride, and lithium tetraborate. The mixture may include one or more lithium compounds as the fluxing agent. In an embodiment where the mixture includes lithium nitrate as the fluxing agent, lithium nitrate (LiNO₃) is provided in a molar ratio of 6% in the mixture with respect the total amount of Ca²⁺ and Ln³⁺ in the mixture. The inventors have, through their own research, experiments, and trials, devised that such molar ratio is of particularly advantageous in doping lanthanide ions into the base material. For example, the inventors found that at least 2 mol % to 3 mol % of lanthanide ions can be incorporated (i.e. doped) into the base material lattice completely while the pure phase of the base material is maintained after doping. In other words, the resultant mechanoluminescent material may have a minimal amount of impurities after doping with the lanthanide ions, preventing the material from obtaining undesirable properties such as low emission intensity.

In a particular embodiment, in the step a), the mixture contains calcium carbonate, zinc sulfide, a lithium compound as described above and a lanthanide compound as described above to provide the lanthanide ions. The above components may be provided with a ratio according to the formula of Ca₁₋ₓLnₓZnOS and the lithium compound is present in the molar ratio of 6%.

The method of present invention includes a step b) of heat-treating the mixture to obtain the mechanoluminescent material. In particular, the mixture may be heat-treated in a closed environment with the supply of an inert gas. For example, the mixture may be subjected to sintering or calcination in a furnace. Preferably, the mixture is subjected to sintering at a temperature of about 700 to 1100° C., particularly 900 to 1100° C., preferably 1100° C. under a nitrogen atmosphere for at least 1 hour or about 2 hours in a furnace. The sintered product may then be cooled to room temperature in the furnace.

In an embodiment where the base material has or essentially consists of CaZnOS and the dopant ion is lanthanide ion, the resultant mechanoluminescent material prepared according to the method as described herein is a lanthanide-doped CaZnOS material having a general formula of CaZnOS:Ln³⁺. The resultant mechanoluminescent material may be obtained in crystal form.

After obtaining the mechanoluminescent material from the step b), the method may further include a step c) of grinding the mechanoluminescent material into powder form. The mechanoluminescent material may be ground into uniform particles for a period of time such as 30 minutes for subsequent characterization and/or usage.

The mechanoluminescent material as prepared according to the present invention preferably contains at least 2 mol %, or from about 2 mol % to about 3 mol % of a lanthanide ion as the dopant ion. The doped material allows the material to have a brighter emission (i.e. higher quantum yield) as compared with other existing lanthanide-doped mechanoluminescent materials prepared by other methods. In addition, the method of the present invention is generally applicable to various lanthanide ions as mentioned above. Thus, the mechanoluminescent materials of the present invention are capable of providing an emission with emission wavelengths spanning the whole emission spectrum, such as from green to near-infrared. By further combining different mechanoluminescent materials of the present invention, it is appreciated that the emission wavelength/colors of the resultant material can be tuned easily, which is a property that is particularly useful in displays, sensors, and the like.

Therefore, in the second aspect of the present invention, there is provided a composite material comprising a first mechanoluminescent material prepared as described above. The composite material of the present invention is useful in various applications including, but not limited to, electronic devices such as displays and sensors, medical or cosmetic applications such as manufacture of artificial skin, packaging, anti-counterfeiting applications such as safety labeling, biometric authentication, clothing and accessories, and the like. The composite material may form a part of an article or a device for the respective purpose.

The first mechanoluminescent material in the composite material includes at least 2-3 mol % of a lanthanide ion as described above. This amount of the lanthanide ion specifically enhances the emission intensity of the mechanoluminescent material and exceptionally suitable for manufacture of stress sensitive article or device.

In an embodiment, the first mechanoluminescent material includes a general formula of CaZnOS:Ln³⁺, and Ln³⁺ is a lanthanide ion selected from the group consisting of Tb³⁺, Pr³⁺, Nd³⁺, Sm³⁺, Eu³⁺, Dy³⁺, Ho³⁺, Er³⁺, Tm³⁺ and Yb³⁺. The first mechanoluminescent material may have an emission wavelength of from about 500 to about 1000 nm, covering the range of green color to near-infrared. For example, the first mechanoluminescent material including CaZnOS:Pr³⁺, CaZnOS:Ho³⁺, CaZnOS:Er³⁺ or any combination thereof may emit green light; the first mechanoluminescent material including CaZnOS:Dy³⁺ may emit yellow light; whereas the first mechanoluminescent material including CaZnOS:Tm³⁺, CaZnOS:Nd³⁺, CaZnOS:Yb³⁺ or any combination thereof may emit near-infrared radiation. The distinctive emission characteristic of the first mechanoluminescent material is useful in producing devices with highly tunable emission color.

In an embodiment, the emission intensity of the first mechanoluminescent material may be positively associated with the magnitude of applied force. That is, the larger amount the force applied on the material, the stronger the emission intensity. It is advantageous in that the composite material is suitable for stress sensitive applications.

In an embodiment, the composite material contains or consists of more than one mechanoluminescent material. The first mechanoluminescent material of the present invention may be highly compatible with other mechanoluminescent materials so as to form a composite material with improved properties such as broadened emission wavelength and/or enhanced radiation intensity. The color emitted by the composite material may be adjusted by varying the amount or ratio of the one or more mechanoluminescent materials in the composite material.

In one embodiment, the composite material further includes a second mechanoluminescent material having an emission wavelength different from the first mechanoluminescent material. The second mechanoluminescent material may form a mixture with the first mechanoluminescent material at a predetermined weight ratio thereby tuning the emission wavelength as well as the emission spectrum of the composite material. In particular, the second mechanoluminescent material may include crystals having a substantially the same crystalline size as that in the first mechanoluminescent material. As such, the second mechanoluminescent material may have a substantially the same emission intensity as the first mechanoluminescent material. This may be advantageous since the emission color of the first mechanoluminescent material will not be easily overwhelmed by the second mechanoluminescent material, or vice versa. A skilled person may therefore only have to concern the weight ratio of the mechanoluminescent materials during the color tuning process, rendering the tuning process simple.

In an embodiment, the first mechanoluminescent material may include a material having an emission wavelength of from about 520 to about 560 nm (i.e. green color) such as CaZnOS:Tb³⁺ whereas the second mechanoluminescent material may include a material having an emission wavelength of from about 635 to about 700 nm (i.e. red color) such as CaZnOS:Mn²⁺. By varying the ratio of CaZnOS:Tb³⁺ CaZnOS:Mn²⁺ from, for example, 3:0 to 0:3, the emission color of the composite material may be tuned from green, yellow, orange, to red.

In a further embodiment, the first mechanoluminescent material and the second mechanoluminescent material may be doped with the same lanthanide ions. In this embodiment, the first and second mechanoluminescent material may have different emission wavelength thereby broadening the emission spectrum of the composite material.

The preparation of the composite material can be relatively simple, cost-effective, and time-saving. In an embodiment, the composite material may be prepared by mixing the first mechanoluminescent material and/or the second mechanoluminescent material with a polymeric medium such as polydimethylsiloxane (PDMS) to obtain a viscous mixture, thereby forming the composite material. The composite material may then be filled into a capsule preferably comprising polyethylene glycol terephthalate (PET) to form a ML article or device.

In a further aspect, the present invention pertains to the use of the mechanoluminescent material as described above for stress sensing. The mechanoluminescent material may be formed as a part or an essential component of a mechanoluminescent device which is capable of emitting ML signals upon a mechanical excitation. The signals may be recorded and manipulated to produce an emission intensity profile that is associated with the magnitude of applied force. Thus, by referring to the emission intensity profile, the magnitude of the applied force may be revealed. Further, the determination of the applied force may be used to differentiate various manipulations performed by an user for subsequent processing or tasks.

Still further, the present invention pertains to the use of the mechanoluminescent material as described above or a ML article or device comprising said material for anti-counterfeiting or for security purpose. In an embodiment, the ML article or device may include at least one mechanoluminescent material being arranged in a particular pattern for example characters or figures for encrypting information. Said material within the article or device may then be mechanically excited such that the particular pattern containing the encrypted information is visualized. In an embodiment, the mechanoluminescent material is used in packaging and labeling. The package or the label contains or formed by the mechanoluminescent material or composite material as described above. The presence of said materials allows the package or label to contain anti-counterfeiting pattern or information for consumers to recognize and differentiate the associated objects from counterfeit ones.

Compared to the existing photoluminescent materials, the mechanoluminescent material of the present invention is advantageous in that it only requires a mechanical force for excitation and does not need extra excitation source such as ultraviolet lamps and near-infrared lasers. Therefore, it can provide an easier and cost-effective approach for anti-counterfeiting and security applications.

### EXAMPLES

### Chemicals and Reagents

CaCO₃ (purity of 99.9%), ZnS (purity of >97%), TbF₃ (purity of 99.99%), MnCl₂.4H₂O, LiNO₃, and NH₄F (purity of >98%) were all purchased and used as received. PrF₃, NdF₃, SmF₃, EuF₃, DyF₃, HoF₃, ErF₃, TmF₃ and YbF₃ were obtained by dissolving the corresponding oxide Pr₂O₃, Nd₂O₃, Sm₂O₃, Eu₂O₃, Dy₂O₃, Ho₂O₃, Er₂O₃, Tm₂O₃ and Yb₂O₃ using nitric acid and precipitated by addition of excessive amount of NH₄F. The obtained lanthanide fluoride powders were dried overnight at 100° C. for subsequent synthesis of lanthanide-doped CaZnOS.

### Example 1

### Preparation of Mechanoluminescent Material

The powder precursors of the mechanoluminescent material were provided according to the ratio of Ca_{1-X}Tb_{X}ZnOS (0.06Li⁺) (X=0.002, 0.005, 0.01, 0.02, 0.03, 0.04, and 0.08). The precursors were thoroughly mixed by grinding in an agate mortar. The mixed powder mixture was then sintered in a furnace at 1100° C. for 2 hours under N₂ atmosphere. The sintered product was cooled to room temperature in the furnace and ground again into powders for subsequent characterizations and use.

### Example 2

### Preparation of Mechanoluminescent Device and Patterned Film

The synthesized ML powders were in crystal form (0.3 g) and were mixed with polydimethylsiloxane (PDMS) (0.01 g) and sealed uniformly between two squared polyethylene glycol terephthalate (PET) sheets (3.5 cm×3.5 cm). For the preparation of patterned ML films, a total area of 4 cm×2 cm rectangle was divided into four parts and each part was filled with a distinct type of ML material/composite material. The amount of ML material/composite material was weighted based on the area of the corresponding rectangle.

The ML device can create ML signals under single-point dynamic pressure of a ball-point pen. The ML signal can be visualized either by human eyes or recorded by a digital camera.

### Example 3

### Characterization of Mechanoluminescent Materials and Effect of a Lithium Compound

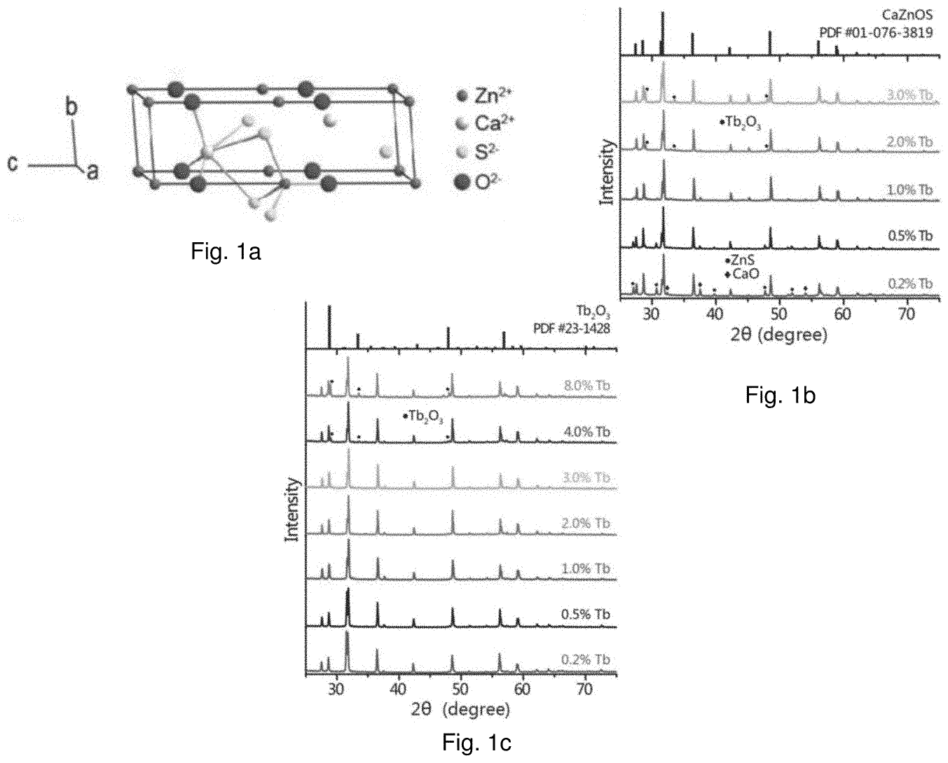

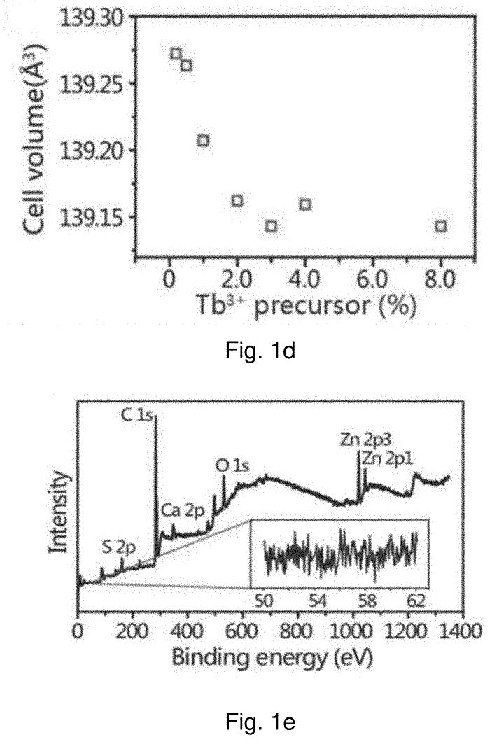

With reference to FIG. 1a, there is shown the crystal structure of CaZnOS. The CaZnOS host contains two types of cation sites, namely Zn²⁺ (CN4, 0.60 Å) and Ca²⁺ (CN6, 1.00 Å). FIGS. 1b and 1c show the XRD characterization of Tb³⁺-doped CaZnOS synthesized without (FIG. 1b) and with (FIG. 1c) the assistance of LiNO₃, respectively. Without the use of LiNO₃, unreacted ZnS and CaO impurities were clearly seen at a low Tb³⁺ concentration (0.2%). The unreacted impurities gradually disappeared with increasing TbF₃ content, suggesting that fluoride promotes chemical reactions between ZnS and CaO. However, Tb₂O₃ impurities were formed at a concentration of Tb³⁺ precursor as low as 1%, indicating that Tb³⁺ ions were not effectively incorporated into the CaZnOS lattice. When lithium nitrate was involved in the synthesis (6 mol % with respect to the total amount of Ca²⁺ and Tb³⁺), the formation of doped CaZnOS is greatly improved. No noticeable impurity phases were detected in the Tb³⁺ concentration range of 0.2-3% under the same experimental conditions (FIG. 1c).

FIG. 1d shows the structural analysis of the Tb³⁺-doped CaZnOS crystals by Rietveld refinement using total pattern analysis solution (TOPAS). The results revealed a steady decrease of cell volume with increasing dopant concentration of Tb³⁺ to 3%, supporting successful substitution of Tb³⁺ dopant for the larger host Ca²⁺ ions (0.92 versus 1.00 Å). The X-ray photoelectron spectroscopy (XPS) spectrum obtained from CaZnOS:Tb (3%) showed that the Li 1s peak was absent from the spectrum (FIG. 1e), indicating that lithium nitrate plays the role of a fluxing agent rather than a co-dopant.

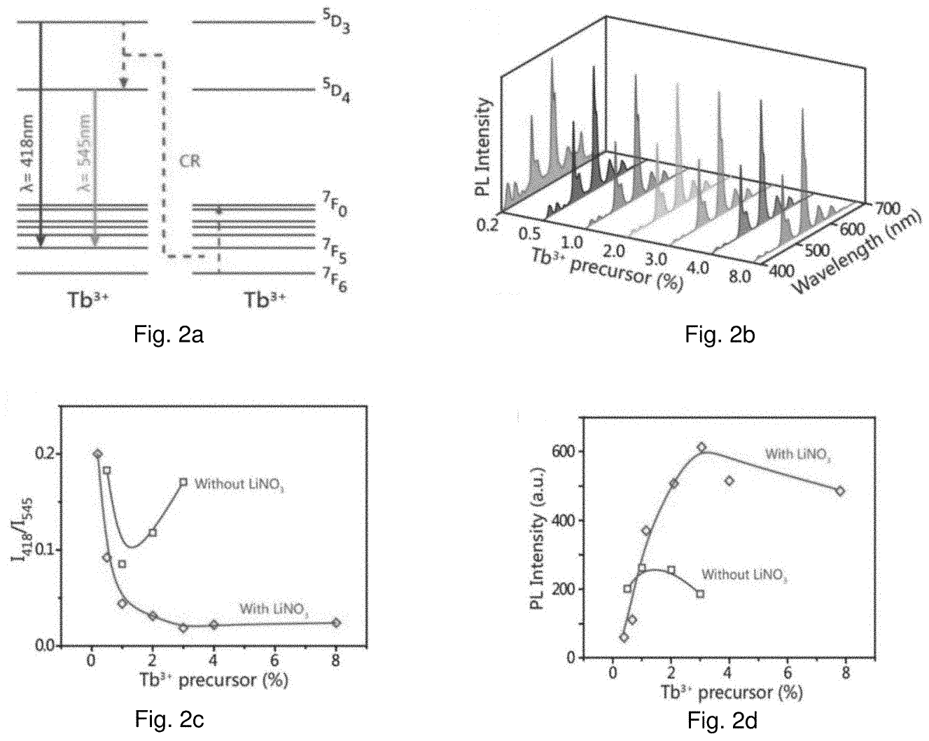

The effective incorporation of Tb³⁺ into the host lattice was validated by spectroscopic investigations. Due to ⁵D₃+⁷F₆→⁵D₄+⁷F₀ cross-relaxation between neighboring Tb³⁺ dopants (FIG. 2a), the emission peaks corresponding to ⁵D₃→⁷F_{J} transitions are attenuated with respect to those originating from ⁵D₄→⁷F_{J} transitions as dopant concentration of Tb³⁺ increases. With reference to FIG. 2b, the photoluminescence (PL) spectra showed a steady decrease in the emission intensity ratio of I₄₁₈ (⁵D₃→⁷F₅) and I₅₄₅ (⁵D₄→⁷F₅) for samples prepared in the presence of increasing amount of Tb³⁺ precursors from 0.2 to 3%. Further attenuation of the emission from ⁵D₃ state was not observed on continuous increase in the concentration of Tb³⁺ precursors. The results suggested that no more Tb³⁺ dopants could enter the host lattice, which is in good agreement with the XRD characterization of the samples.

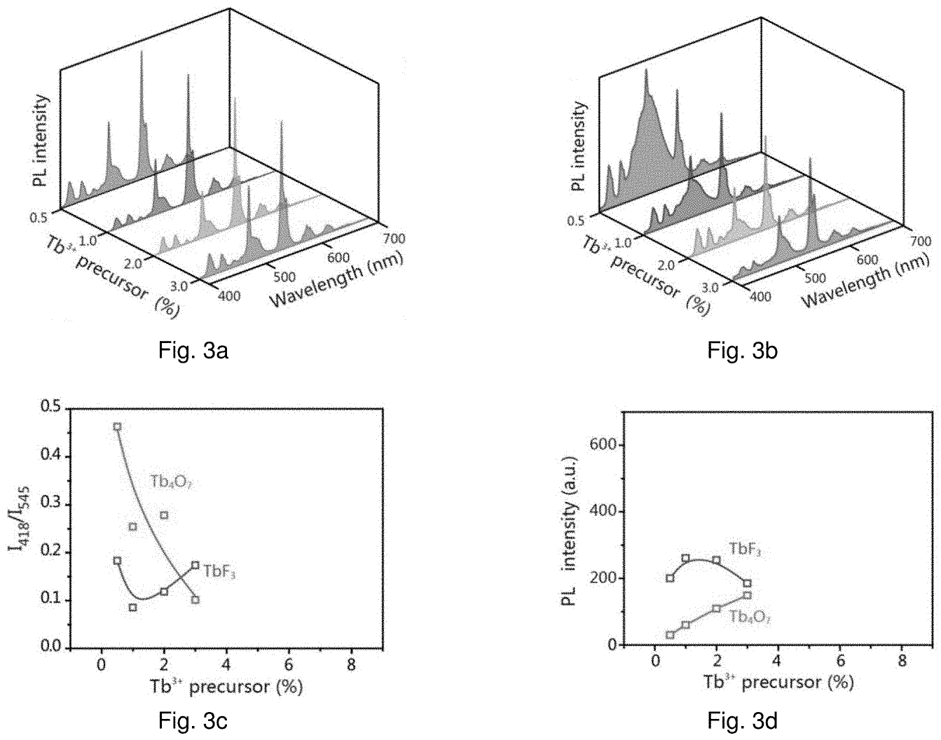

Notably, higher I₄₁₈/I₅₄₅ ratios were detected for samples prepared in the absence of LiNO₃ (FIG. 2c), and it is irrespective of the use of fluoride or oxide precursors (FIG. 3c). These results revealed that the actual concentration of dopants in the host lattice is relatively low. In addition, it is notable that the PL spectra for samples prepared using Tb₄O₇ precursors were typically dominated by host emissions, indicating an extremely low concentration of Tb³⁺ dopants in the host lattice (FIG. 3d). The effect of LiNO₃ on promoting the incorporation of lanthanide ions into the CaZnOS lattice is further supported by the enhanced emission intensity at 545 nm (⁵D₄ ⁷F₅) under 486 nm (⁷F₆→⁵D₄) excitation (FIG. 2d).

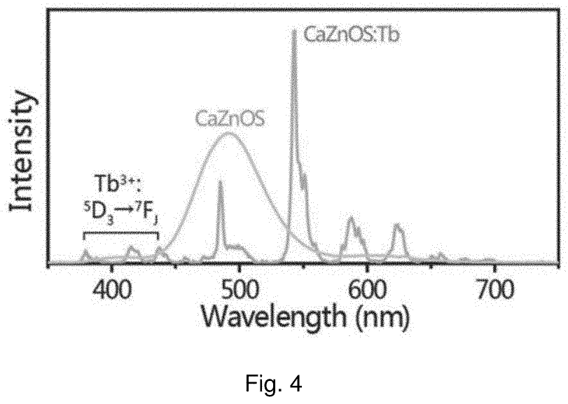

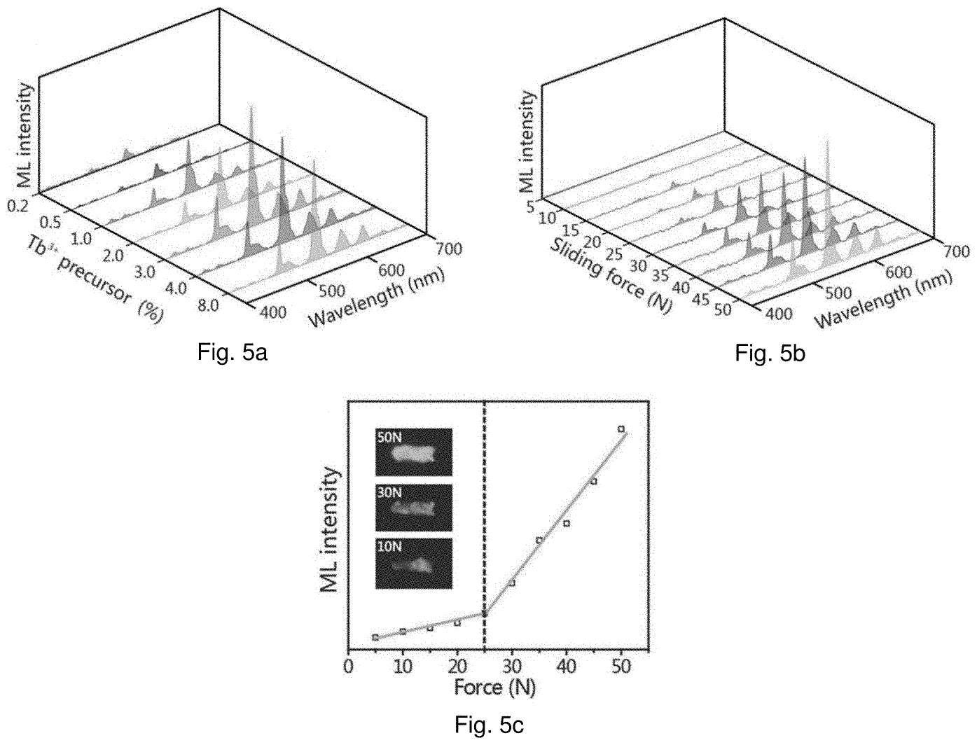

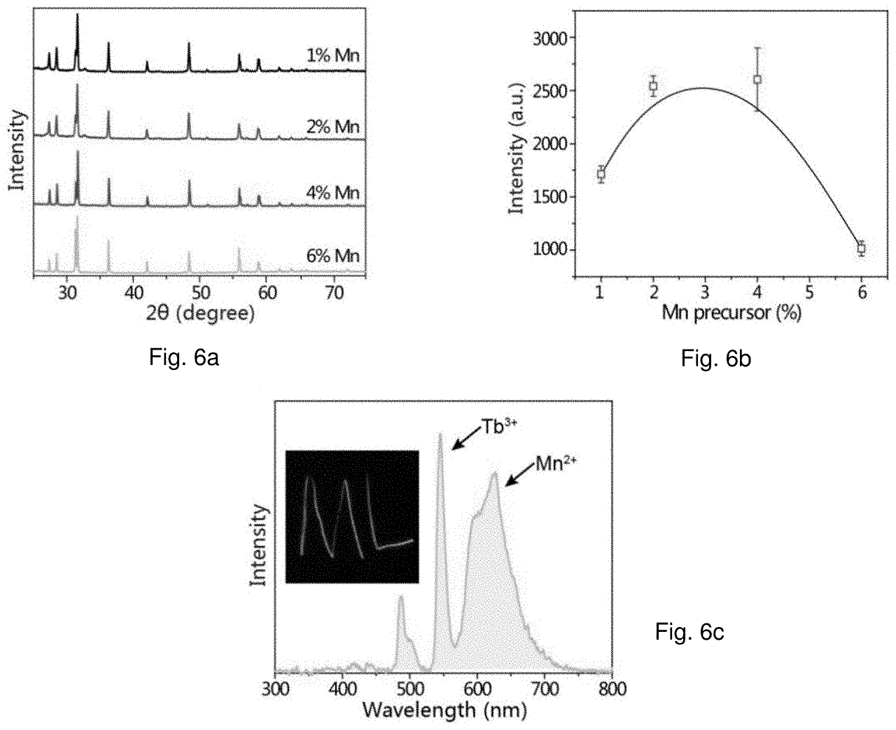

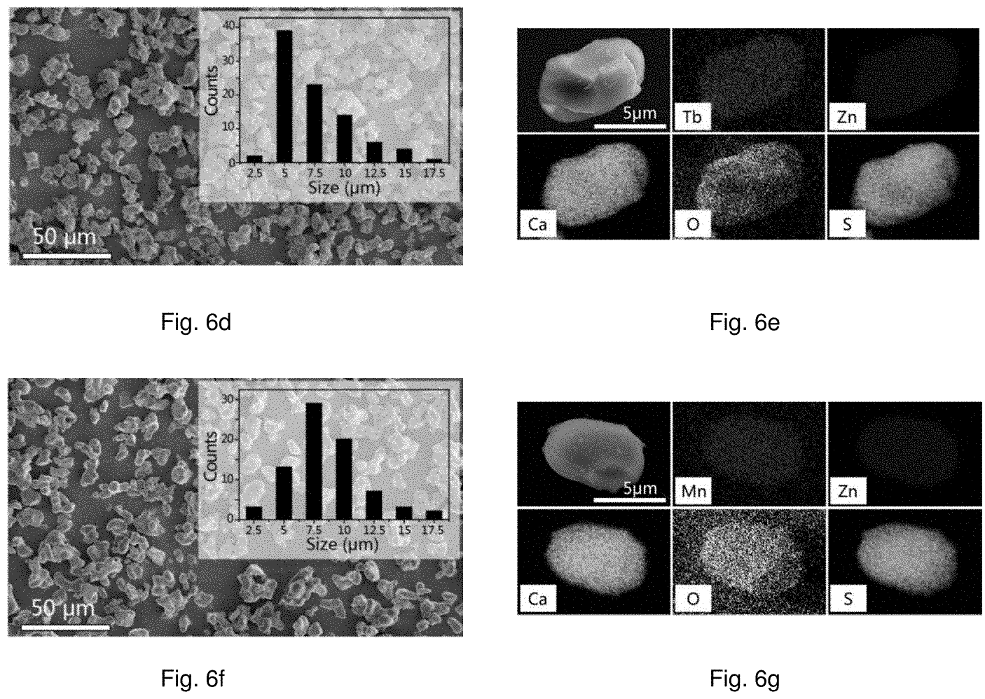

The ML properties of the Tb³⁺-doped CaZnOS crystals were investigated. ML spectrum of the Tb³⁺-doped CaZnOS showed characteristic emission peaks spanning from violet to red spectral region, which is due to electronic transitions from both the ⁵D₃ and ⁵D₄ states of Tb³⁺ (FIG. 4). However, an intrinsic defect emission peak was located at ˜490 nm (FIG. 4), which is insufficient for populating the ⁵D₃ state of Tb³⁺. Thus, it is speculated that the excitation of Tb³⁺ dopants may be established by upconversion through successive energy transfer. With reference to FIG. 5a, the results also showed that the samples prepared with 3% of Tb³⁺ precursor displayed the strongest ML intensity. These observations were ascribed to the highest Tb³⁺ content in the host lattice and therefore extracting the most amount of energy from the host. Thus, effective lanthanide doping through the use of lithium nitrate as a fluxing agent is important for boosting ML intensity. Notably, the 3% Tb³⁺-doped CaZnOS renders a comparative photoluminescence quantum yield (25.3% versus 27.3%) and ML intensity to that of existing CaZnOS:Mn (FIGS. 6a to 6c), demonstrating high efficiency of the lanthanide-doped CaZnOS for ML.

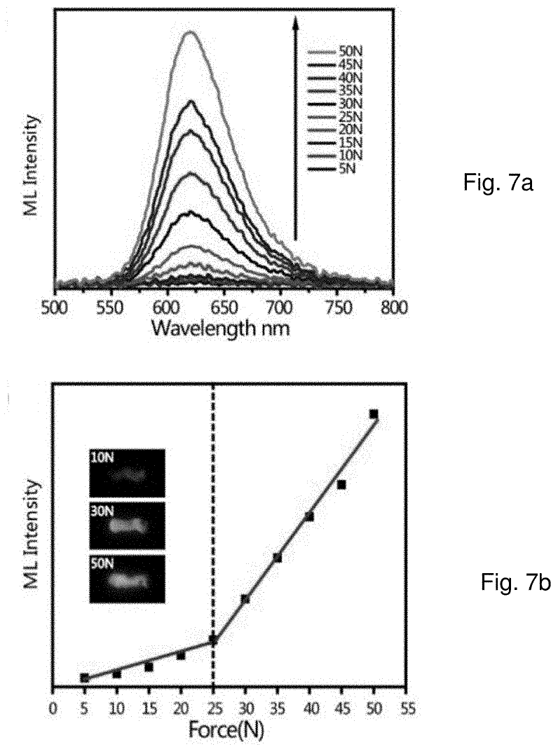

The ML performance of the Tb³⁺-doped CaZnOS crystals under different amount of forces was also assessed. In general, the ML intensity increases with increasing the amount of applied force (FIG. 5b). In particular, two distinct regions can be clearly identified for the stress-dependent ML behavior (FIG. 5c), suggesting a variation of ML mechanism as the amount of applied force increases. The ML at relatively low strength of force (<25N) is ascribed to the triboelectric effect in which frictional contact between PET and ML crystals induce tribocharge at the contact surface. The electric potential associated with the surface charges is responsible for the excitation of electrons. With increasing amount of applied forces, distortion of the CaZnOS host appears and causes a dramatic change in piezoelectric potential of the host, thereby leading to a rapid growth of the ML intensity. The same ML dependence on applied forces was also observed for Mn²⁺-doped CaZnOS (FIGS. 7a and 7b), indicating generality of the underlying mechanism.

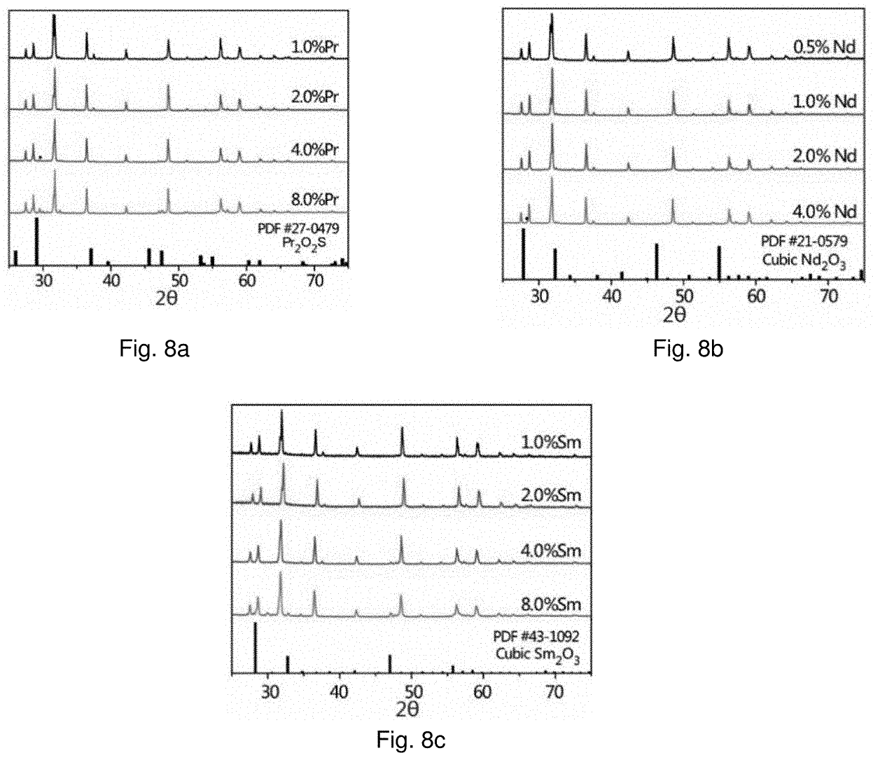

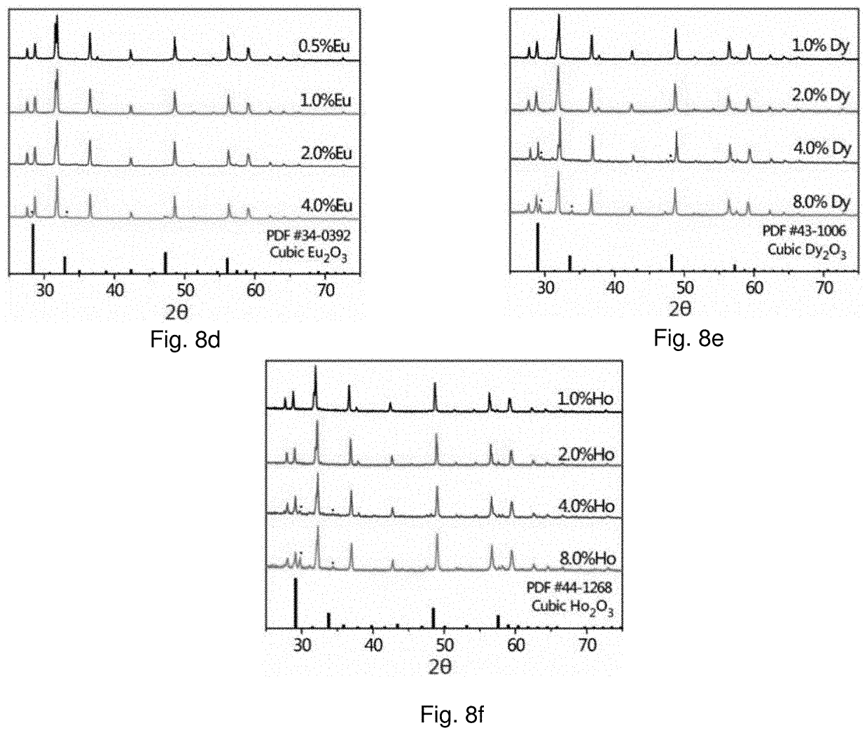

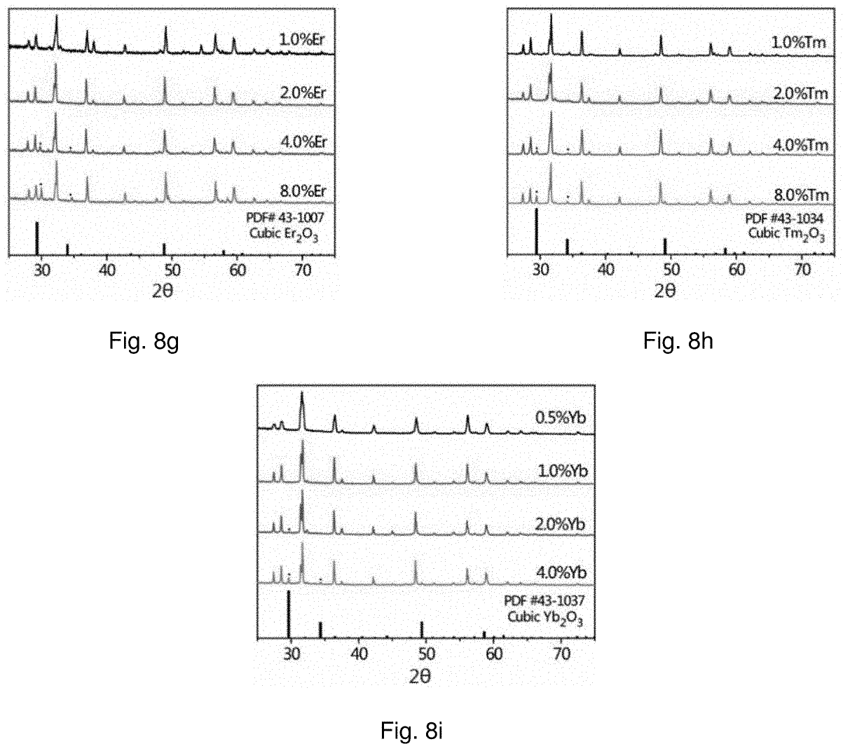

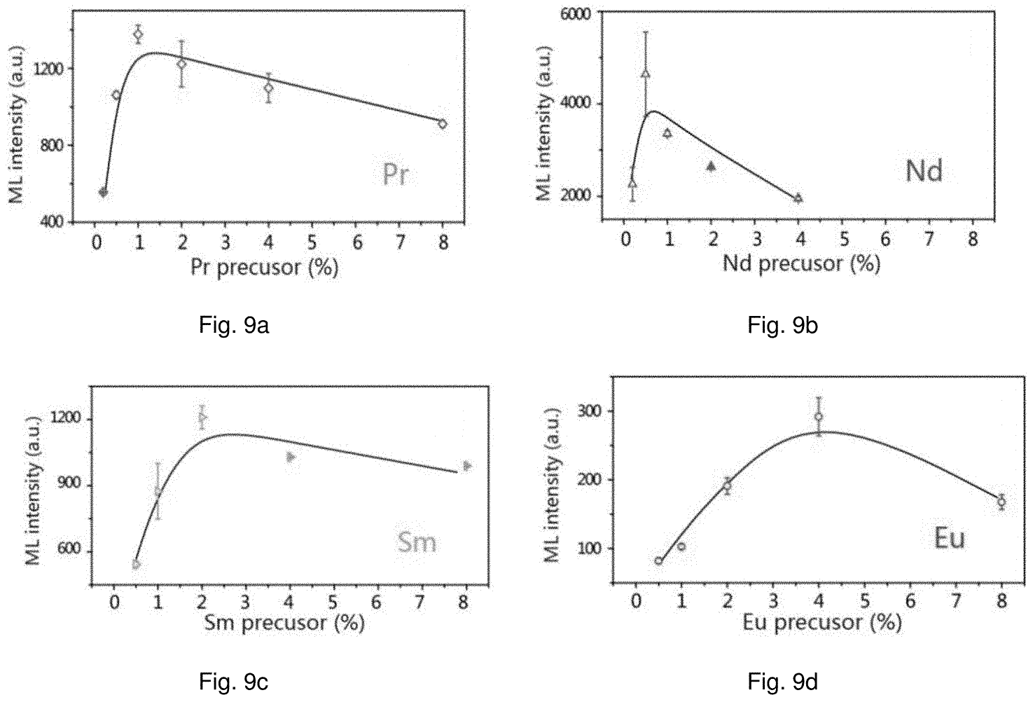

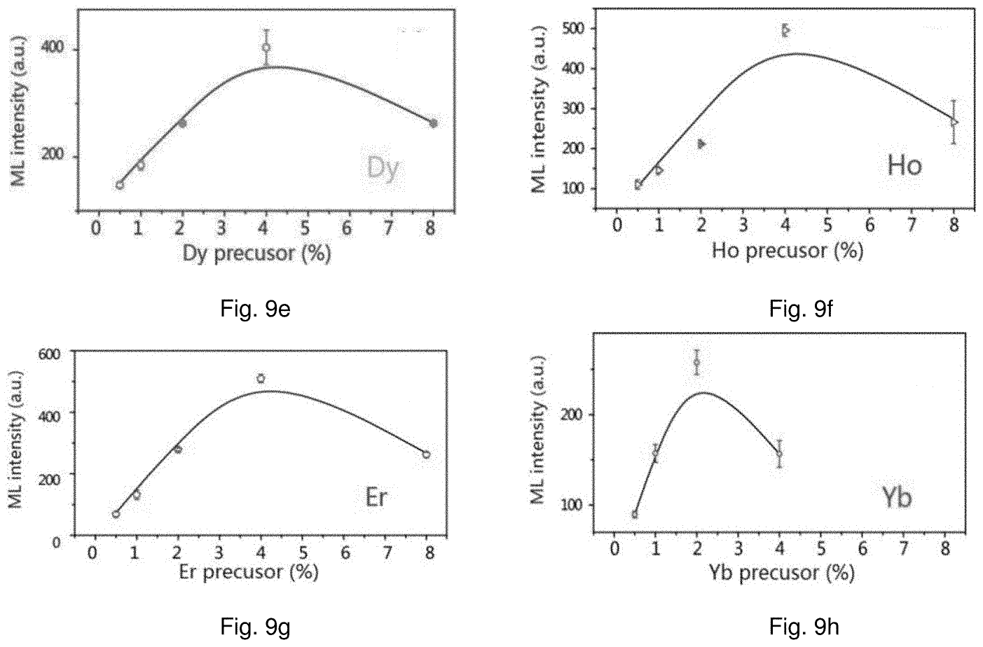

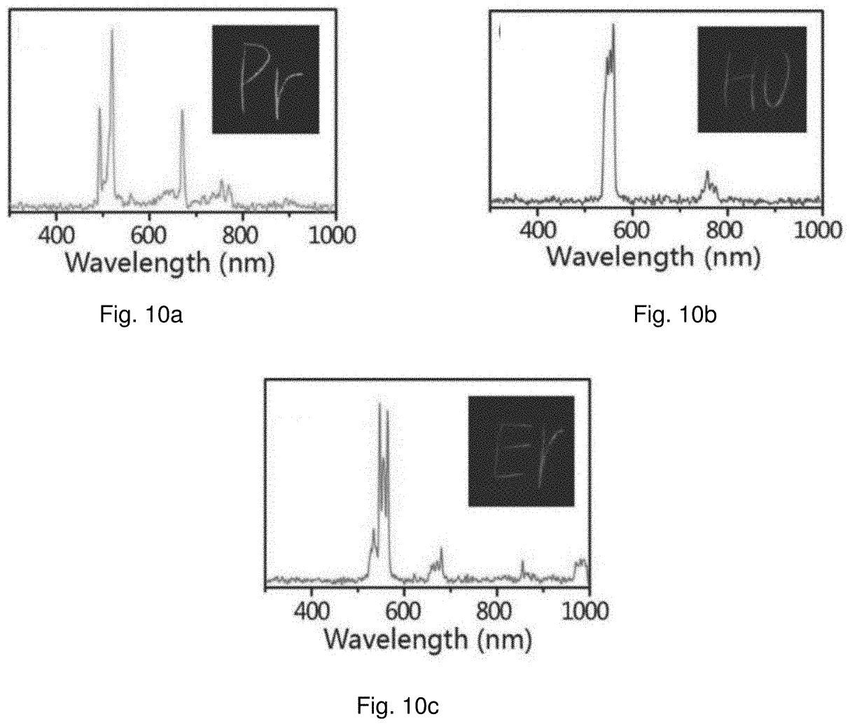

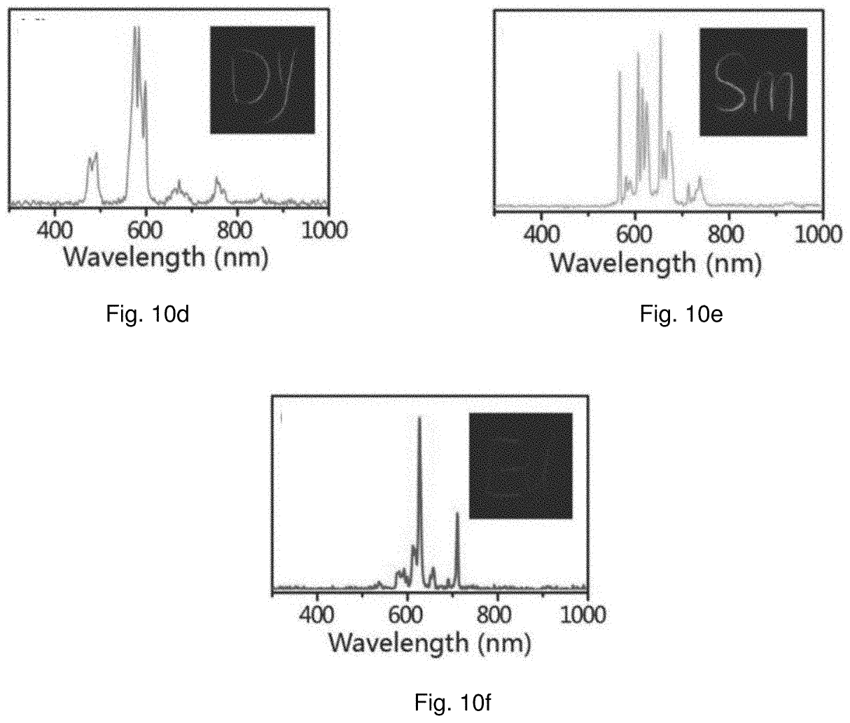

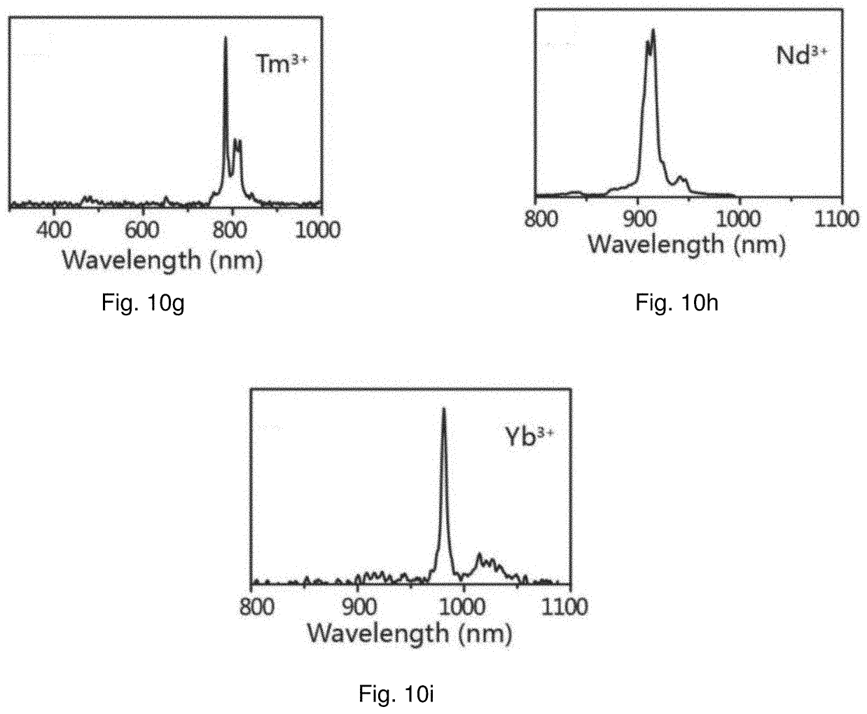

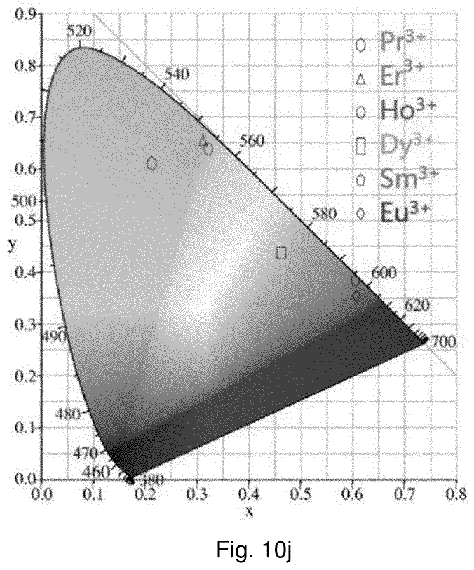

The Li-assisted annealing protocol is equally effective for incorporation of other types of lanthanide ions (i.e. activators) into CaZnOS crystals. With reference to FIGS. 8a to 8i, the XRD measurements revealed that the products possess a single phase at a dopant concentration of 2%. Whilst further increasing the dopant concentration may result in minor impurity phase for heavy lanthanides, it is inevitable that a continuous growth of the emission intensity was typically detected (FIGS. 9a to 9h). Thus, it is appreciated that more than 2% of lanthanide dopants can be generally incorporated into the CaZnOS host by using the synthetic protocol of the present disclosure. Owing to the relatively high dopant concentration, these CaZnOS crystals all display intense mechanoluminescent emission or radiation, spanning a broad spectral range from green (CaZnOS:Pr, CaZnOS:Ho, and CaZnOS:Er), to yellow (CaZnOS:Dy), red (CaZnOS:Sm and CaZnOS:Eu), and near-infrared (CaZnOS:Tm, CaZnOS:Nd, CaZnOS:Yb) (FIGS. 10a to 10j).

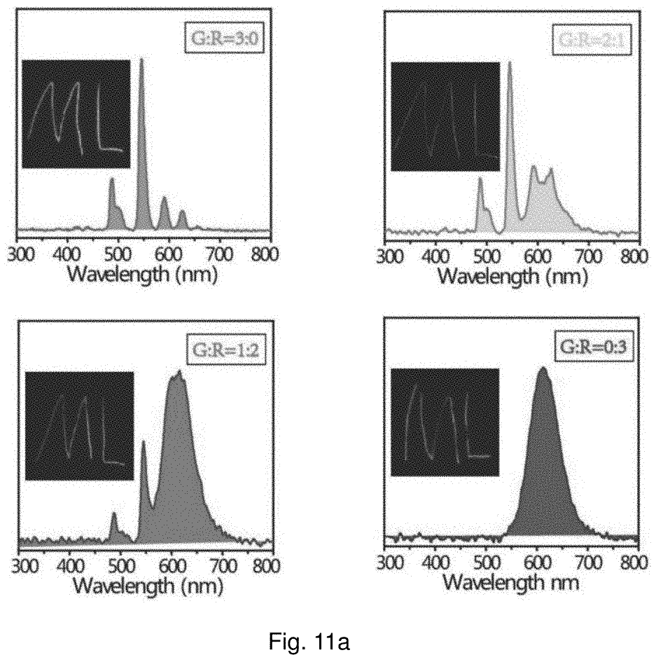

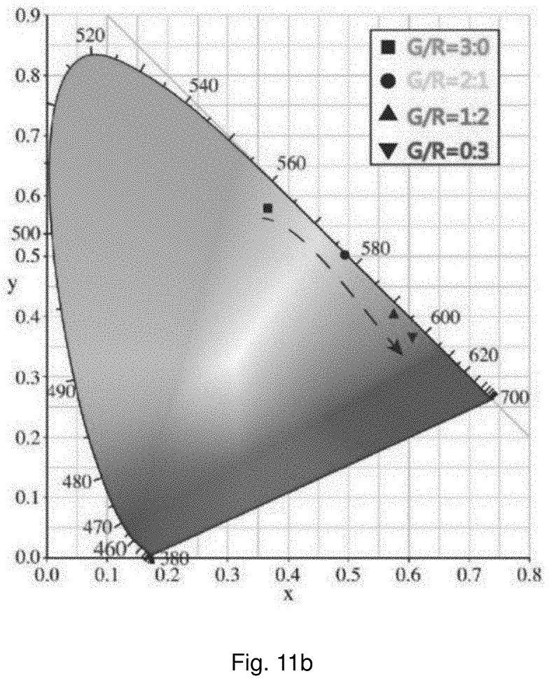

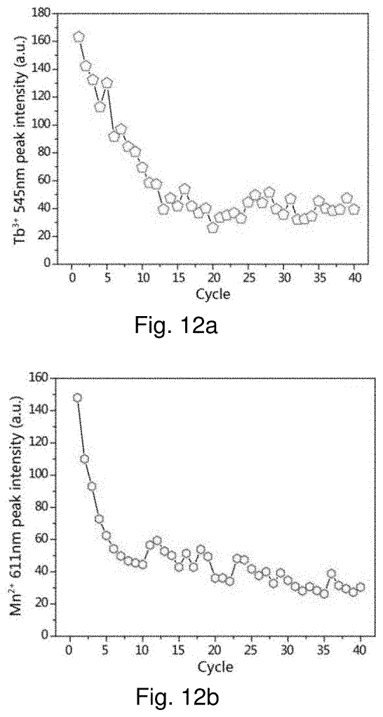

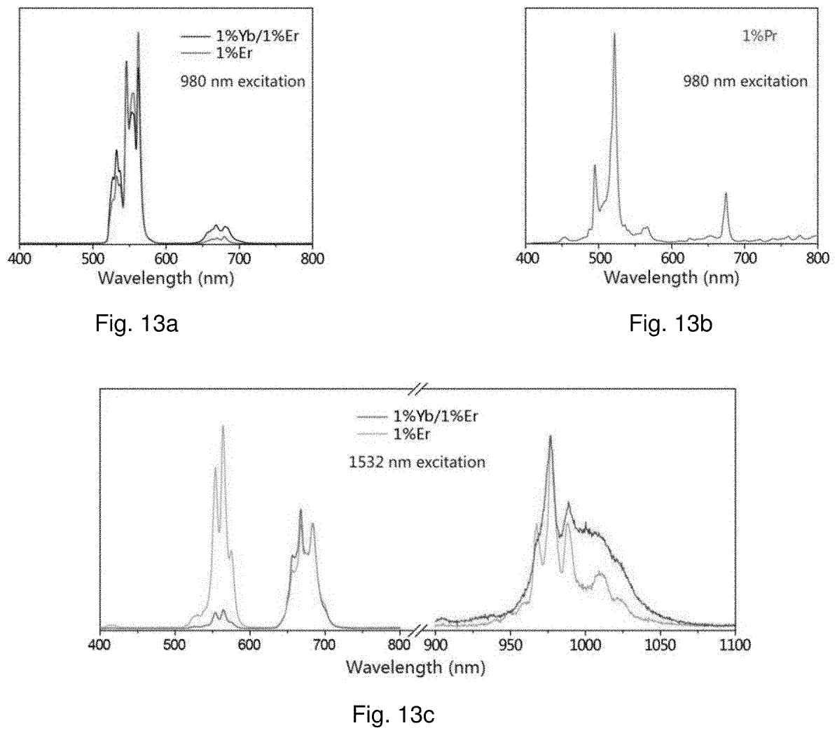

The ML color can be alternatively manipulated by using mixtures of differently doped CaZnOS crystals, that is, a composite material including more than one doped CaZnOS crystal. As an example, the green emitting CaZnOS:Tb crystals (denoted as “G” component) were mixed with classical red emitting CaZnOS:Mn (denoted as “R” component) for color tuning. Owing to their comparative emission intensity, the composite material displayed dual emissions from both the G and R components. By adjusting the weight ratio of the G and R components, the relative intensity ratio of the dual emissions can be precisely manipulated (FIG. 11a). The adjustable balance of emission intensities allows precise manipulation of ML color from green to red (FIG. 11b). Importantly, the ML signal can be preserved after repeated mechanical actions (FIGS. 12a and 12b). As an added benefit, the lanthanide-doped CaZnOS crystals preserve excellent photoluminescence properties of the lanthanide ions such as tunable photon upconversion (FIG. 13), which imparts additional modalities to the platform for extra high-level security protection.

### Example 4

### Stress Sensing Applications of ML Device

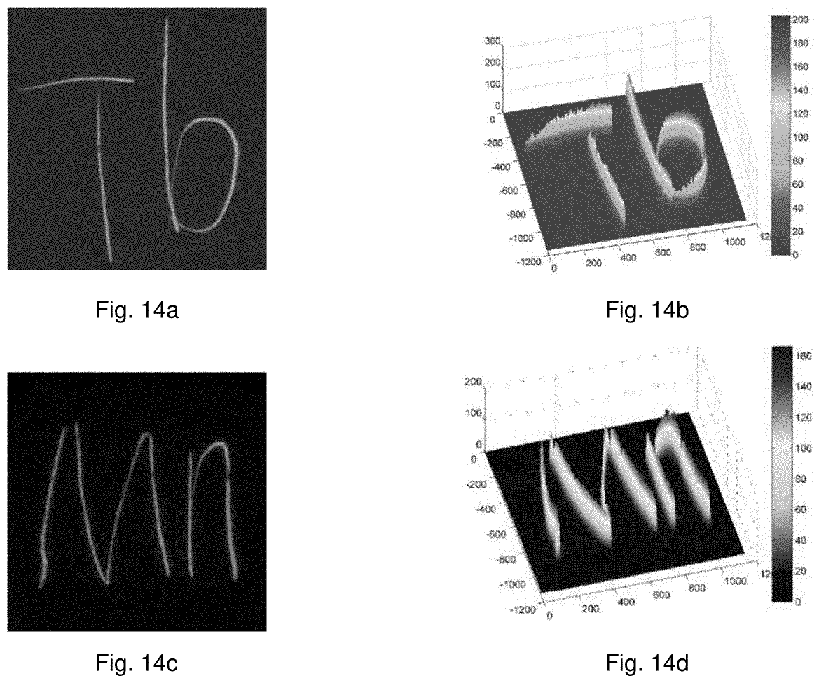

The CaZnOS:Tb crystals are characterized in that they release photons rapidly and show no afterglow emissions. This feature together with the positive correlation between ML intensity and applied force is particularly useful for stress sensing. To illustrate this property, the ML signals from a thin film comprising the ML crystals under single-point dynamic pressure of a ball-point pen (ball diameter: 0.7 mm) were recorded. A digital camera with a long-duration shutter speed was used for capturing 2D distribution of the emissions. As shown in FIG. 14a, a 2D planner pressure map by capturing a handwritten letter “Tb” was visualized. By extracting the gray scale of the ML photograph, the relative ML intensities were derived and shown in FIG. 14b. The intensity profile clearly reveals the variation of relative intensity between different points on the trajectory, demonstrating capability of this platform for acquiring detailed pressure information. The similar stress sensing application can also be realized based on the CaZnOS:Mn ML materials (FIGS. 14c and 14d), indicating generality of the this types of ML materials for stress sensing applications.

### Example 5

### Anti-Counterfeiting Applications of Patterned ML Film

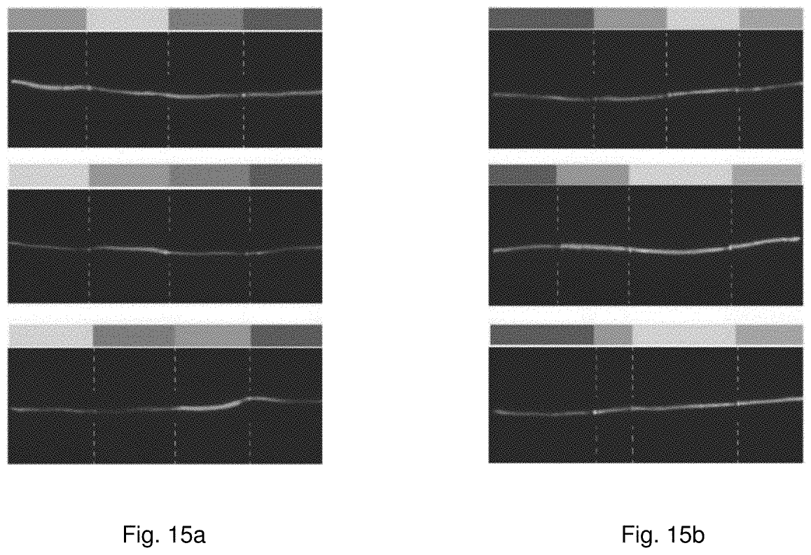

An anti-counterfeiting pattern composed of ML strip arrays was prepared. As shown in FIGS. 15a and 15b, 6 patterns were prepared and each of the patterns was formed by 4 different ML materials with different strip width. Each ML strip was tagged with a particular type of ML material. By writing across the strips with a ball-point pen, a sequence of color segments corresponding to the encrypted information can be extracted. Through control of permutations of the ML materials and/or sizes of the strips, distinct covert information can be encrypted. The 4 different ML materials used in this example are the composite materials containing CaZnOS:Tb and CaZnOS:Mn at different ratios as prepared in Example 3.

1. A method of preparing a mechanoluminescent material comprising the steps of:
a) providing a mixture including precursors of a base material, a fluxing agent, and at least one lanthanide ion;
b) heat-treating the mixture to obtain the mechanoluminescent material; and
c) optionally grinding the mechanoluminescent material into powder form;
wherein the fluxing agent facilitates incorporation of the at least one lanthanide ion into the base material.

2. The method of claim 1, wherein the fluxing agent includes a lithium compound.

3. The method of claim 2, wherein the lithium compound is provided in a molar percentage of 6% in the mixture.

4. The method of claim 1, wherein the mixture includes a lanthanide fluoride to provide the at least one lanthanide ion.

5. The method of claim 1, wherein the lanthanide ion includes at least one of Tb³⁺, Pr³⁺, Nd³⁺, Sm³⁺, Eu³⁺, Dy³⁺, Ho³⁺, Er³⁺, Tm³⁺ or Yb³⁺.

6. The method of claim 1, wherein the precursors of base material include calcium carbonate and zinc sulfide.

7. The method of claim 6, wherein the calcium carbonate is provided at an atomic ratio with respect to the at least one lanthanide ion by 1-x:x, wherein x is 0.002, 0.005, 0.01, 0.02, 0.03, 0.04 or 0.08.

8. The method of claim 1, wherein the mechanoluminescent material includes lanthanide-doped CaZnOS crystals having a general formula of CaZnOS:Ln³⁺.

9. The method of claim 1, wherein the step a) further includes a step of grinding the mixture into a powder form.

10. The method of claim 8, wherein the mechanoluminescent material includes at least 2-3 mol % of doped lanthanide.

11. The method of claim 1, wherein the step b) includes the step of sintering the mixture at a temperature of about 1100° C. under a nitrogen atmosphere for about 2 hours.

12. A composite material comprising a first mechanoluminescent material, wherein the first mechanoluminescent material includes at least 2-3 mol % of a lanthanide ion.

13. The composite material of claim 12, wherein the first mechanoluminescent material has an emission wavelength of from about 500 to about 1000 nm.

14. The composite material of claim 12, wherein the first mechanoluminescent material has a general formula of CaZnOS:Ln³⁺, wherein Ln³⁺ is a lanthanide ion selected from the group consisting of Tb³⁺, Pr³⁺, Nd³⁺, Sm³⁺, Eu³⁺, Dy³⁺, Ho³⁺, Er³⁺, Tm³⁺ and Yb³⁺.

15. The composite material of claim 12 further includes a second mechanoluminescent material having an emission wavelength different from the first mechanoluminescent material.

16. The composite material of claim 15, wherein the first mechanoluminescent material and the second mechanoluminescent material are provided in a mixture at a predetermined weight ratio thereby tuning the emission wavelength of the composite material.

17. The composite material of claim 15, wherein the second mechanoluminescent material includes crystals having a substantially the same crystalline size as that in the first mechanoluminescent material.

18. The composite material of claim 15, wherein the second mechanoluminescent material has a substantially the same emission intensity as the first mechanoluminescent material.

19. The composite material of claim 15, wherein the second mechanoluminescent material has an emission wavelength of from about 635 to about 700 nm.

20. The composite material of claim 15, wherein the second mechanoluminescent material includes CaZnOS:Mn²⁺.

21. The composite material of claim 15, wherein the first mechanoluminescent material includes CaZnOS:Tb³⁺.
